(19) United States
(12) Patent Application Publication
(10) Pub. No.: US 2023/0042035 A1
(43) Pub. Date: Feb. 9, 2023

(54) POWER SUPPLY CONNECTION FOR ARRANGEMENT IN THE REGION OF AN OUTER CONTOUR OF AN ELECTRIC VEHICLE, AND ELECTRIC VEHICLE

(71) Applicant: BOS GMBH & CO. KG, Ostfildern (DE)

(72) Inventors: Samuel ADAMS, Kalamazoo, MI (US); Ryan ARNOLDY, Ortonville, MI (US); Christian SCHRECK, Ostfildern (DE)

(21) Appl. No.: 17/882,122

(22) Filed: Aug. 5, 2022

Related U.S. Application Data
(60) Provisional application No. 63/230,174, filed on Aug. 6, 2021.

(51) Int. Cl. B60L 53/16

(52) U.S. Cl. CPC B60L 53/16

(57) ABSTRACT

A power supply connection for arrangement in the region of an outer contour of a motor vehicle, in particular of an electric vehicle, having a power supply opening associated with a housing mounted on the vehicle in a ready-to-operate functional state. The power supply opening can be closed by a closing cover mounted movably on the vehicle between an open position and a closed position and actuated by an electrically activatable control device coupled to a capacitive sensor system in order to allow the closing cover to be opened and/or closed depending on a gesture control operation by a person in the region of the power supply opening. The closing cover is of an electrically conductive design and is electrically coupled to the capacitive sensor system.

### CROSS REFERENCE TO RELATED APPLICATION

This claims priority of U.S. Provisional Application No. 63/230,174, filed Aug. 6, 2021, the disclosure of which is hereby incorporated by reference in its entirety.

### TECHNICAL FIELD

The invention relates to a power supply connection for arrangement in the region of an outer contour of an electric vehicle having a power supply opening which is associated with a housing mounted on the vehicle in the ready-to-operate functional state and which can be closed by a closing cover which is mounted movably on the vehicle between an open position and a closed position and can be actuated by means of an electrically activatable control device which is coupled to a capacitive sensor system in order to allow the closing cover to be opened and/or closed depending on a gesture control operation by a person in the region of the power supply opening. The invention additionally relates to an electric vehicle having a power supply connection of this kind.

### BACKGROUND AND SUMMARY

Such a power supply connection is known from the magazine “Auto Motor and Sport”, issue 13/2021, page 107, for a Porsche Taycan. The electric vehicle in the form of the Porsche Taycan has a cutout in the region of a front side wing in the outer skin of the vehicle body, said cutout serving as a power charging opening. The power charging opening has an associated electrical power charging socket in order to be able to establish a connection to a static charging station. The power charging socket is provided in a housing which is mounted fixed to the vehicle. The power charging opening is closed by a charging flap which can be moved between a closed position and an open position by means of an electrical control device. A capacitive sensor system is arranged laterally next to the power charging opening in the region of the outer skin of the vehicle body, said capacitive sensor system being coupled to the electrical control device for the charging flap in such a way that a hand movement by an operator laterally next to the power charging opening and therefore also next to the charging flap is identified by the capacitive sensor system and the charging flap is moved in a corresponding manner from the closed position to an open position.

The object of the invention is to provide a power supply connection of the kind mentioned at the outset which exhibits improved accessibility as compared to the prior art.

This object is achieved in that the closing cover is of electrically conductive design and is electrically coupled to the capacitive sensor system. Owing to the solution according to the invention, an operator can make a hand movement directly in the region of an outer side of the closing cover in order to open the closing cover. In the case of the prior art however, an operator has to touch a specific outer contour region of the outer skin of the vehicle body laterally next to the charging flap in order to be able to cause a corresponding movement of the closing cover. According to the invention however, the sensitivity of the capacitive sensor system is greatly increased by the electrical conductivity of the closing cover itself, and therefore a hand movement without touching the outer side of the closing cover already leads to activation of the control device for the closing cover. A contact-free gesture by an operator can accordingly lead to the closing cover opening. In the same way, a movement of an object or a mechanical structure can also lead to the closing cover opening. In particular, activation and accordingly opening can be performed by a charging robot which is active in the region of a static charging station for a charging process of the electric vehicle. In addition, no installation space for the capacitive sensor system is required laterally next to the power supply opening—in contrast to the prior art —, and therefore the outer skin of the vehicle body can be provided around the power supply opening in accordance with other criteria, without having to take the position of the capacitive sensor system into consideration. The capacitive sensor system can be mounted on the housing at a distance behind the closing cover. The solution according to the invention is particularly advantageously suitable for electric vehicles which are provided with an exclusively electric traction drive or with a hybrid traction drive. Electric vehicles with a hybrid traction drive further have, in addition to an internal combustion engine, an electric traction drive which can operate the electric vehicle in a purely electric manner over a short range. In the same way, the solution according to the invention is, however, also suitable for power supply connections which serve to fill a motor vehicle with liquid fuel, provided that the closing cover for a filling opening of this kind can likewise be moved electrically between a closed position and an open position. Appropriate fuels may be fossil fuels, alternative fuels or else hydrogen. The power supply connection according to the invention can be positioned at different locations in the region of a vehicle outer contour of the motor vehicle. The power supply connection is advantageously positioned such that it is ergonomically readily accessible to an operator. According to the invention, the closing cover itself is of electrically conductive design and is electrically coupled to the capacitive sensor system. The closing cover can advantageously form a plate of a plate capacitor. Owing to the coupling of the closing cover to the capacitive sensor system, an electrostatic field is formed in the region of an outer side of the closing cover, said electrostatic field necessarily changing when an object, such as in particular a finger of a hand, is moved through this field. Owing to the solution according to the invention, it is possible for the capacitive sensor system to detect gestures in the region of the outer side of the closing cover which are made up to a distance of approximately 50 mm in the region of the outer side. The capacitive sensor system can consist of an individual capacitive sensor or of a plurality of capacitive sensors spaced apart from one another, all of which are coupled to a common electronic control unit.

In one refinement of the invention, the closing cover has a carrier part and also an outer panel fastened to the outer side of the carrier part and of electrically conductive design. The outer panel can be painted in a color which corresponds to an exterior color of the vehicle. The electrical conductivity of the outer panel can assist in the application of paint.

In a further refinement of the invention, the closing cover is permanently coupled to the capacitive sensor system via at least one electrical conductor. The electrical conductor can be designed in the form of an electrical wire which is electrically connected to the closing cover and the capacitive sensor system. As an alternative, the electrical conductor can be designed in such a way that there is a permanent electrical coupling between the capacitive sensor system and the closing cover. The permanent coupling advantageously functions only in the operating state of the power supply connection and the closing cover. The coupling can be disconnected in the open position of the closing cover. In addition, the coupling can be deactivated when the closing cover is blocked for an opening process, preferably when the electric vehicle is locked. This prevents the closing cover from being undesirably opened. If the electrical conductor is designed in the form of a flexible wire, this wire can also remain permanently coupled to the sensor system and the closing cover in a non-operative position of the power supply connection or the electric vehicle. The length and the flexibility of this wire can then advantageously be matched to a movement path of the closing cover between the closed position and the open position in such a way that an electrical connection between the closing cover and the sensor system is maintained over the entire movement path.

In a further refinement of the invention, the closing cover consists of a conductive thermoplastic material. In other words, the thermoplastic material has electrical conduction properties.

In a further refinement of the invention, the closing cover consists of a blend based on polyamide and polyphenyl ether (PA and PPE) or of a blend of polycarbonate and acrylonitrile butadiene styrene (PC and ABS). These plastic blends are conductive and can form an electrostatic field.

In a further refinement of the invention, an electrical coupling between the electrically conductive closing cover and the capacitive sensor system has a metal pushbutton which is mounted on the vehicle-side housing and bears in a permanently spring-elastic manner against the inner side of the closing cover in the closed position of the closing cover. This provides the permanent electrical coupling between the sensor system and the closing cover in the closed position of the closing cover.

In a further refinement of the invention, an electronic control unit is associated with the capacitive sensor system, said control unit evaluating changes in an electric field in the region of an outer side of the closing cover and also initiating a control function, in particular activating the electrical control device of the closing cover, depending on a result of the evaluation. The preferred control function is that of moving the closing cover from the closed position to its open position by means of activating the electrical control device. Corresponding changes in the electric field in the region of the outer side of the closing cover are detected by the capacitive sensor system. Depending on the configuration of the electronic control unit, the electronic control unit can distinguish not only between gestures by an operator, but rather also environmental events such as rain, wind, snow or hail and activate suitable control functions of the electric vehicle which can influence different driving function or comfort settings of the motor vehicle. Therefore, it is advantageously possible to adjust running gear of the motor vehicle in an appropriate manner as early as when the motor vehicle is stationary when rain, hail or snow is identified.

In a further refinement of the invention, the outside of the closing cover is provided with an electrically conductive layer. The layer can be applied to the outer side of the closing cover as a layer of paint containing electrically conductive particles, as an electrically conductive foil or in a similar way.

An additional object of the invention is to provide an electric vehicle of the kind mentioned at the outset which allows power supply in a manner simplified for an operator.

This object is achieved by the features of claim 9. The improved accessibility to the power supply connection ensures very simple charging of the vehicle with power or very simple filling with fuel for an operator.

### BRIEF DESCRIPTION OF THE DRAWINGS

Further advantages and features of the invention can be found in the claims and in the following description of preferred exemplary embodiments of the invention which are illustrated using the drawings, in which

FIG. 1 schematically shows a subregion of an outer contour of an electric vehicle having a power supply connection closed by a closing cover according to one embodiment of the invention;

FIG. 2 schematically shows a section through the power supply connection along section line II-II in FIG. 1; and

FIG. 3 shows a sectional illustration analogously to section line II-II in FIG. 1 of a further embodiment of a power supply connection according to the invention.

### DETAILED DESCRIPTION

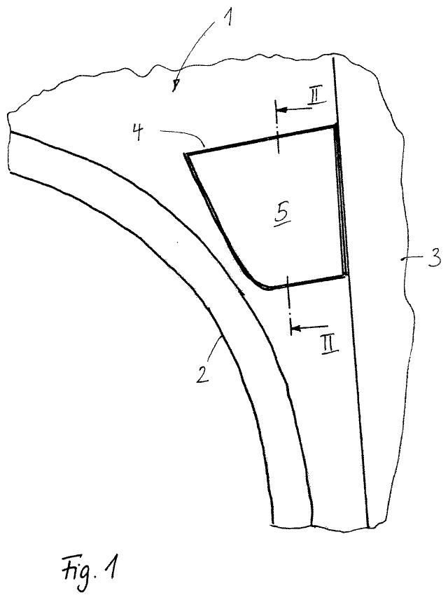

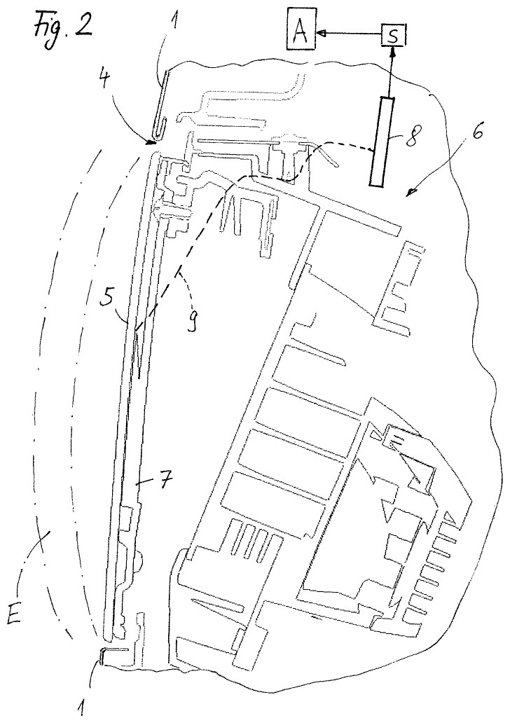

An electric vehicle in the form of a passenger car has an outer skin 1 of a vehicle body, which outer skin forms an outer contour of the electric vehicle. With reference to FIG. 1, the outer skin 1 of the vehicle body is shown in the region of a front left-hand-side wing 2 and also in the transition region to a front side door 3. The electric vehicle has an electric traction drive which is supplied with power by a vehicle battery. In order to charge the vehicle battery, the electric vehicle has a power supply connection with comprises a power charging socket, not designated in any detail. The power charging socket, which is not designated in any detail, is diagrammatically indicated with reference to FIG. 2. The power supply connection is provided in the region of a cutout 4 in the outer skin 1 of the vehicle body. The cutout 4 forms a power supply opening. The power supply opening is closed by a closing cover 5, also referred to as a charging flap. The closing cover 5 is mounted movably on the vehicle between the closed position, illustrated in FIG. 1, and an open position opening the power supply opening and therefore also the power charging socket. In the closed position, the closing cover 5, by way of its outer contour, terminates flush and in alignment with the outer skin 1 of the vehicle body.

In order to move the closing cover 5 between the closed position and the open position, control kinematics, not illustrated in any detail, are provided, these being actuated by an electrically activatable control device. Owing to activation of the control device, the control kinematics move the closing cover 5 from the closed position to the open position, and back. The control kinematics and therefore also the electrically activatable control device have an associated electric actuating drive which is not illustrated in FIGS. 1 to 3 and which drives the control kinematics and therefore the closing cover 5 in the event of a corresponding displacement movement.

The control device for actuating the actuating drive and therefore for moving the closing cover 5 can be activated by gesture control from an outer side of the closing cover 5 and therefore from an outer side of the outer skin 1 of the vehicle body. Firstly, a capacitive sensor system 8 is provided for this purpose. The capacitive sensor system 8 is arranged on the vehicle and fixedly connected to a housing 6 of the power supply connection which is fixedly connected to corresponding vehicle parts on the inner side of the cutout 4 and therefore of the power supply opening. The closing cover 5 is mounted movably between the closed position and the open position relative to the housing 6.

The closing cover 5 has a carrier part 7 and also an outer panel fixedly connected to the carrier part 7. The outer panel of the closing cover 5 is of electrically conductive design and electrically coupled to the capacitive sensor system 8 via an electrical conductor 9. The electrical conductor 9 is merely schematically illustrated in FIG. 2 in order to symbolize an electrical connection between the sensor system 8 and the outer panel of the closing cover 5. In the illustrated exemplary embodiment, the outer panel consists of a conductive thermoplastic material. In the present case, the outer panel of the closing cover 5 is produced either as a blend on a polyamide basis and a polyphenyl ether basis or from a blend of polycarbonate and acrylonitrile butadiene styrene. The outer side of the outer panel is painted in accordance with the painting of the outer skin 1 of the vehicle body.

Owing to the electrical connection of the outer panel of the closing cover 5 to the capacitive sensor system 8 via the at least one electrical conductor 9, the electric field generated by the capacitive sensor system 8 is amplified and according to FIG. 2 moved outward to the outer side of the outer panel of the closing cover 5. On the basis of the illustration of the electric field E in FIG. 2 using dash-dotted lines, it can be seen that an electric field is produced over the total outside dimensions of the closing cover 5 with the capacitive sensor system activated, said electric field necessarily changing as an object or limbs of a person approaches/approach in the direction of the outer side of the outer panel 5. This field change is detected via the capacitive sensor system 8 and evaluated by means of an electronic control unit S which is coupled to the capacitive sensor system 8.

When a respective operator uses their hand to make a gesture in the region of the closing cover 5, which is in its closed position, on the outer side of the outer skin 1 of the vehicle body, i.e. in front of the outer side of the outer panel of the closing cover 5, the electronic control unit S can detect the corresponding field change signals of the sensor system 8, evaluate them and drive the actuating drive A for the control kinematics of the closing cover 5 in order to move the closing cover 5 from the closed position to the open position.

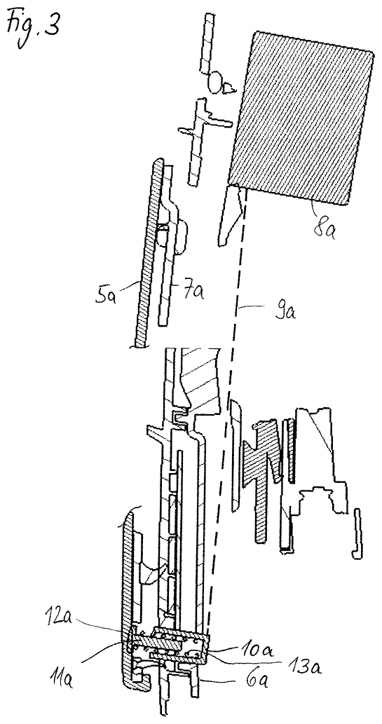

In the embodiment according to FIG. 3, functionally identical parts and portions are provided with the same reference signs, with the addition of the letter a. In order to avoid repetition, reference is additionally made to the description relating to the embodiment according to FIGS. 1 and 2. FIG. 3 also shows a sectional illustration in the region of a power supply connection analogously to FIG. 1. The closing cover 5a also has an outer panel, which is fixedly connected to a carrier part 7a, in the embodiment according to FIG. 3 too. The outer panel is produced from a conductive thermoplastic material analogously to the outer panel of the closing cover 5 according to FIG. 2. The outer panel of the closing cover 5a is also coupled to a capacitive sensor system 8a via an electrical conductor 9a to 13a. The electrical conductor has a metal pushbutton 10a, 11a, 13a which enters a receptacle 12a in the region of an inner side of the outer panel of the closing cover 5a, provided that the closing cover 5a is in its closed position. For this purpose, the metal pushbutton 11a, 10a, 13a has a metal piston 11a which is provided with a head and can be displaced in a linearly movable manner in a metal cylinder 10a or a cylinder 10a that is electrically conductive in some other way. The piston 11a has pressure permanently applied to it in the direction of the outer panel of the closing cover 5a by a metal helical compression spring 13a, and therefore the piston 11a of the metal pushbutton rests permanently in the receptacle 12a of the outer panel in the closed position of the closing cover 5a. Since the outer panel is electrically conductive, an electrically conductive connection between the outer panel and the cylinder 10a is produced by the metal pushbutton. The cylinder 10a of the metal pushbutton is in turn coupled to the capacitive sensor system 8a via an electrical wire 9a or another electrical conductor. The electrical coupling of the sensor system 8a to the electrically conductive outer panel of the closing cover 5a leads, analogously to the embodiment according to FIG. 2, to the formation an electrostatic field E in the region of the outer side of the outer panel of the closing cover 5a in the ready-to-operate functional state of the power supply connection, as a result of which the same control functions can be achieved as in the embodiment according to FIG. 2. The sensor system 8a is also coupled to an electronic control unit analogously to the embodiment according to FIG. 2, which control unit is in turn operatively connected to an actuating drive for the closing cover 5a in order to achieve a desired actuating function.

The power supply connection according to FIGS. 1 and 2 and also the power supply connection according to FIGS. 1 and 3 can each be assembled as a preassembled structural unit and can be prepared to be ready to function, in order to then be able to be mounted on the vehicle in the region of the cutout 4 in the outer skin 1 of the vehicle body in the ready-to-function preassembly state.

1. A power supply connection for arrangement in the region of an outer contour of a motor vehicle, in particular of an electric vehicle, having a power supply opening which is associated with a housing mounted on the vehicle in the ready-to-operate functional state and which can be closed by a closing cover which is mounted movably on the vehicle between an open position and a closed position and can be actuated by means of an electrically activatable control device which is coupled to a capacitive sensor system in order to allow the closing cover to be opened and/or closed depending on a gesture control operation by a person in the region of the power supply opening, wherein the closing cover is of electrically conductive design and is electrically coupled to the capacitive sensor system.

2. The power supply connection according to claim 1, wherein the closing cover has a carrier part and an outer panel fastened to the outer side of the carrier part, and the outer panel is of electrically conductive design.

3. The power supply connection according to claim 1, wherein the closing cover is permanently coupled to the capacitive sensor system via at least one electrical conductor.

4. The power supply connection according to claim 1,
wherein the closing cover consists of a conductive thermoplastic material.

5. The power supply connection according to claim 4, wherein the closing cover consists of a blend based on polyamide and polyphenyl ether or of a blend of polycarbonate and acrylonitrile butadiene styrene.

6. The power supply connection according to claim 1,
wherein an electrical coupling between the electrically conductive closing cover and the capacitive sensor system, has a metal pushbutton which is mounted on the vehicle-side housing and bears in a permanently spring-elastic manner against an inner side of the closing cover in the closed position of the closing cover.

7. The power supply connection according to claim 1,
wherein an electronic control unit is associated with the capacitive sensor system, said electronic control unit evaluating changes in an electric field in the region of an outer side of the closing cover and also initiating a control function, in particular activating the electrical control device of the closing cover, depending on a result of the evaluation.

8. The power supply connection according to claim 1,
wherein an outer side of the closing cover is provided with an electrically conductive layer.

9. An electric vehicle having a power supply connection according to claim 1.
